(19) United States
(12) Patent Application Publication
(10) Pub. No.: US 2019/0066448 A1
(43) Pub. Date: Feb. 28, 2019

(54) GAMING APPARATUS AND ASSOCIATED METHOD

(71) Applicant: Paltronics Australasia Pty Limited, New South Wales (AU)

(72) Inventors: Dean Wright, Sydney (AU); Stephen Cowan, Sydney (AU)

(21) Appl. No.: 16/048,145

(22) Filed: Jul. 27, 2018

(30) Foreign Application Priority Data
Aug. 23, 2017 (AU) 2017903399

(51) Int. Cl. G07F 17/32; G06Q 50/34

(52) U.S. Cl. CPC G07F 17/3276; G06Q 50/34; G07F 17/3223; G07F 17/3262

(57) ABSTRACT

The gaming apparatus includes a plurality of communicatively interlinked electronic gaming machines (EGM 1 to EGM 5). The gaming apparatus also includes a central controller 20, which is communicatively connected via a local area network 21 to the EGM's. Each of the EGMs is configured to execute a game that may generate winnings. The gaming apparatus is configured so as to allow a definition of a group of EGM's from amongst the plurality of EGM's. Each of the EGM's is configured to contribute at least some of the winnings generated by the EGM whilst the EGM is in the group into a group pool. At the conclusion of the grouped gaming session, the gaming apparatus is configured to execute a group cash out routine.

### CROSS-REFERENCE TO RELATED APPLICATION

This patent application claims priority to Australian Patent Application No. 2017903399, filed Aug. 23, 2017, which application is herein incorporated by reference in its entirety.

### FIELD

The present invention relates to gaming methods and associated apparatus. Embodiments of the present invention find application, though not exclusively, in the gaming industry for use in the context of linked networks of electronic gaming machines, such as slot machines for example. Embodiments of the present invention are typically deployed in establishments that provide gaming facilities, such as casinos, pubs, clubs and the like.

### BACKGROUND

It is known to link a number of electronic gaming machines to form a network. Some embodiments of such networks may include a central controller configured to provide secondary gaming, such as jackpot games and the like in which each of the linked electronic gaming machines may participate. This secondary gaming is typically provided in addition to the primary game provided by each of the electronic gaming machines, which may for example be slots, poker, blackjack, bingo, keno, or the like.

It has been appreciated by the inventors of the present invention that it would be advantageous to extend the functionality of such gaming machines so as to provide players with new and interesting options and experiences.

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in Australia or elsewhere before the priority date of this application.

### SUMMARY

It is an object of the present invention to overcome, or substantially ameliorate, one or more of the disadvantages of the prior art, or to provide a useful alternative.

In one aspect of the present invention there is provided a gaming apparatus including: a plurality of communicatively interlinked electronic gaming machines (EGMs), each of the EGMs being configured to execute a game having a potential to generate winnings; the gaming apparatus being configured so as to allow a definition of a group of EGM's from amongst the plurality of EGM's; each of the EGM's being configured to contribute at least some of the winnings generated by the EGM whilst the EGM is in the group into a group pool; the gaming apparatus being configured to execute a group cash out routine whereby funds from the group pool are distributed to players of the EGM's in the group in accordance with a distribution calculation methodology.

In one embodiment each of the EGMs is responsive to a player operable input module so as to allow a player of the EGM to define the group. In this embodiment each of the EGMs is also responsive to a player operable input module so as to allow a player of the EGM to opt to join the EGM into the group.

In another embodiment the gaming apparatus is configurable by an authorized operator so as to define the group.

In one embodiment the gaming apparatus is configured to maintain the group for a predefined length of time, after which the group is automatically disbanded and the group cash out routine is executed.

In another embodiment each of the EGMs in the group is responsive to a player operable input module so as to allow a player of the EGM to opt to disband the group, in response to which the gaming apparatus is configured to execute the group cash out routine.

In yet another embodiment the gaming apparatus is operable by an authorized operator so as to disband the group and execute the group cash out routine.

In one embodiment at least some of the EGM's are configured to execute a primary game having a potential to generate primary winnings wherein a primary game result is substantially independent of gaming activity on the other EGM's and a secondary game having a potential to generate secondary winnings wherein a secondary game result is substantially dependent upon gaming activity on the other EGM's. In this embodiment an EGM generating primary winnings whilst that EGM is in the group may be configured to contribute at least some of the primary winnings generated by the EGM into the group pool. Additionally or alternatively, in this embodiment an EGM generating secondary winnings whilst that EGM is in the group may be configured to contribute at least some of the secondary winnings generated by the EGM into the group pool.

Preferably the gaming apparatus is responsive to a win generated by one of the EGM's in the group so as to provide a win notification to the players of each of the other EGM's in the group.

In one embodiment each of the EGM's in the group is responsive to a group cash out signal so as to execute the group cash out routine in which a credit meter of each EGM is incremented by funds from the group pool in accordance with the distribution calculation methodology.

In another embodiment each of the EGM's is configured to receive an identifier of a player of that EGM and to access information stored within an account associated with the player. In this embodiment each of the EGM's in the group is responsive to a group cash out signal so as to execute the group cash out routine in which the account associated with each player of each EGM in the group is incremented by funds from the group pool in accordance with the distribution calculation methodology.

Preferably the distribution calculation methodology is dependent upon a total amount staked by each player whist in the group. More preferably, an amount of the funds from the group pool distributed to a player as calculated by the distribution calculation methodology is proportional to the total amount staked by that player whist in the group relative to a total amount staked by all players whilst in the group.

In an embodiment the gaming apparatus is configured so as to allow a definition of at least two groups of EGM's from amongst the plurality of EGM's. In this embodiment the gaming apparatus is configured to allow the at least two groups to compete against each other. Preferably a winning group is determined and a bonus or jackpot prize is awarded to the players in the winning group.

In another aspect of the present invention there is provided a gaming method including: providing a plurality of communicatively interlinked electronic gaming machines (EGMs), each of the EGMs being configured to execute a game having a potential to generate winnings; defining a group of EGM's from amongst the plurality of EGM's; contributing at least some of the winnings generated by the EGM whilst the EGM is in the group into a group pool; and executing a group cash out routine whereby funds from the group pool are distributed to players of the EGM's in the group in accordance with a distribution calculation methodology.

The features and advantages of the present invention will become further apparent from the following detailed description of preferred embodiments, provided by way of example only, together with the accompanying drawings.

### BRIEF DESCRIPTION OF THE ACCOMPANYING DRAWINGS

FIG. 1 is a schematic representation of two EGM's in a first embodiment of the present invention;

FIG. 2 is a schematic representation of the first embodiment of the present invention; and

FIGS. 3 and 4 together form a flowchart showing steps performed in an embodiment of the inventive method.

### DETAILED DESCRIPTION

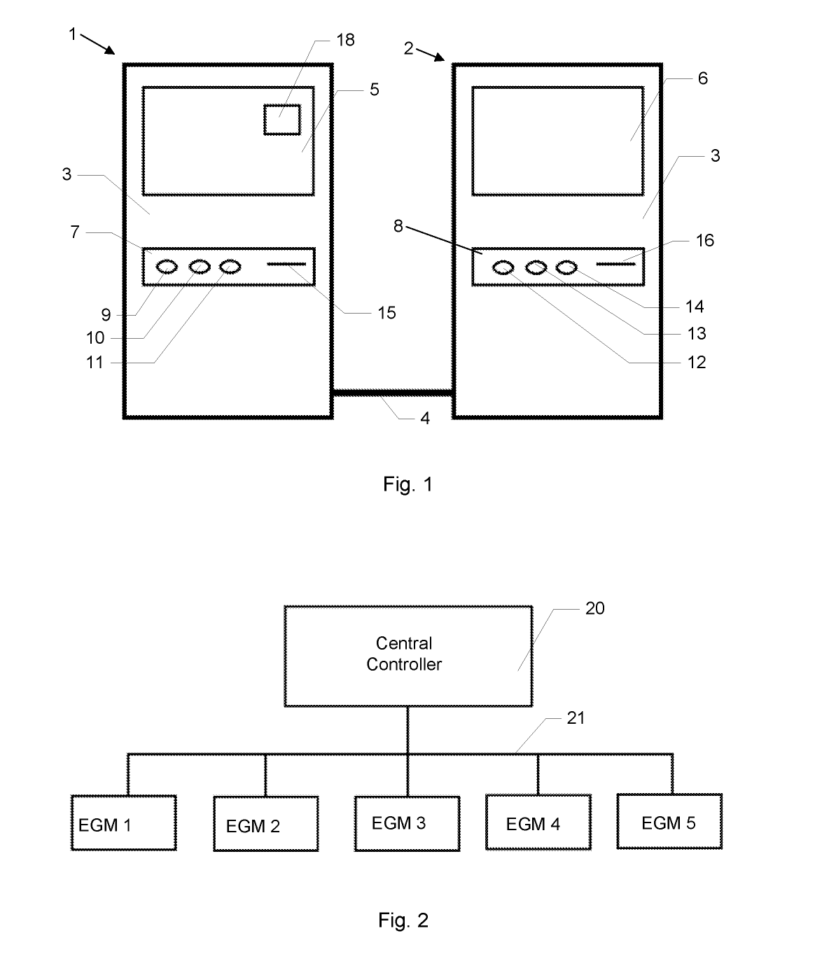

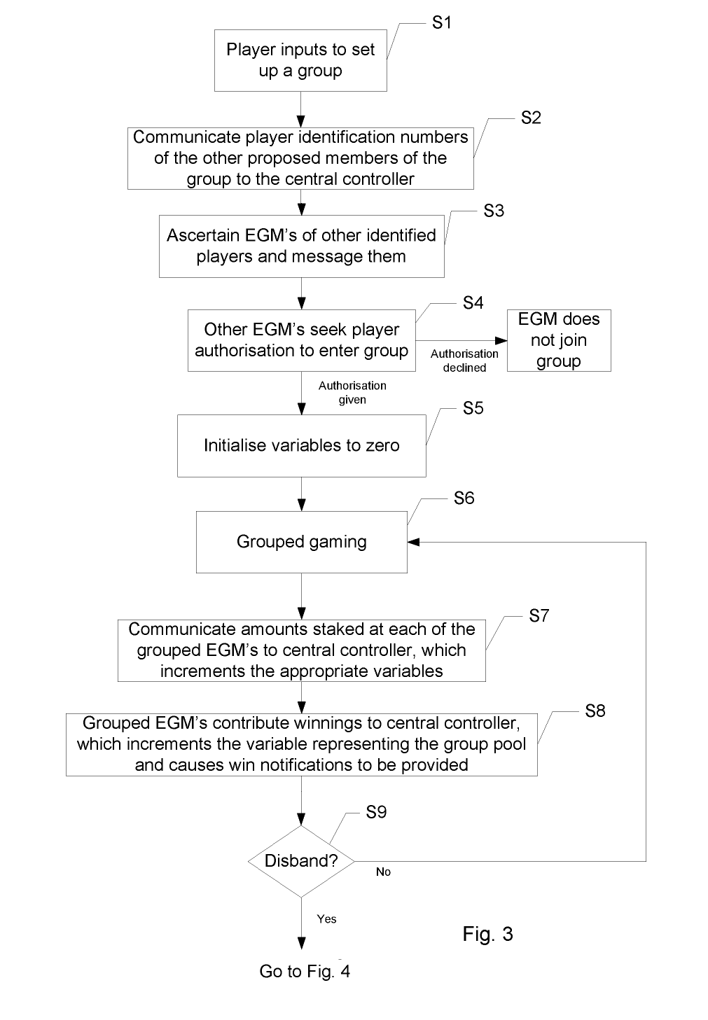

The gaming apparatus includes a plurality of communicatively interlinked electronic gaming machines (EGM's), with the illustrated preferred embodiment having a total of five EGM's as shown in FIG. 2. FIG. 1 depicts two of the EGM's, EGM 1 and EGM 2, in more detail. These may be any type of EGM, for example slot machines, poker machines, blackjack machines, bingo machines, keno machines, EGM's executing one or more games wherein the outcome is at least partially dependent upon player skill, or the like. As illustrated in FIG. 1, the EGM's 1 and 2 are purpose built gaming machines housed within free standing cabinets 3. However in alternative embodiments, the EGM's 1 and 2 take the form of other devices, such as hand held mobile phones, desktop computers, laptop computers, tablets, kiosks etc. The communicative link is provided by networking cable 4, which allows data signals to travel between the plurality of EGM's, although other embodiments make use of alternative linking means, such as a wireless connection, and so forth.

Each of the EGM's 1 and 2 has a processor and associated memory in the form of RAM, ROM and media reader/writers. The processor of each of EGM 1 and 2 executes gaming software, which configures the EGM's to provide one or more games. This also configures the RAM so as to store respective credit values for each of the EGM's 1 and 2. Execution of the gaming software on each of the EGM's has the potential to generate winnings depending upon the rules of the game being executed.

The EGM's 1 and 2 each have a display screen 5 and 6. Additionally, each of the EGM's 1 and 2 has a player input module 7 and 8, which provides buttons 9, 10 and 11 on EGM 1 and buttons 12, 13 and 14 on EGM 2. It will be appreciated, however, that other input devices and hardware may be provided in alternative embodiments. For example, in some embodiments the display screens 5 and 6 are touch sensitive.

EGM 1 has slot 15 and EGM 2 has slot 16. This allows players the option of inserting an identifier, such as a card bearing magnetically encoded information, by which the players may identify themselves to the EGM that they are using so as to participate in the options provided by a player tracking system. The information in the player tracking system may be stored locally on one or both of the EGM's, or it may be stored on a central controller 20 that is communicatively connected via a local area network 21 to the EGM's, as shown in FIG. 2. The information in the player tracking system typically includes the players' names and associated credit amounts that may be either cashed out, or used to fund further gaming activities, at the players' discretion. In the default state, no groupings of EGM's are defined and hence each EGM pays its winnings directly to its own credit meter in the conventional manner. However, as will be described in more detail below, the gaming apparatus is configured so as to allow a definition a group of EGM's from amongst the plurality of EGM's.

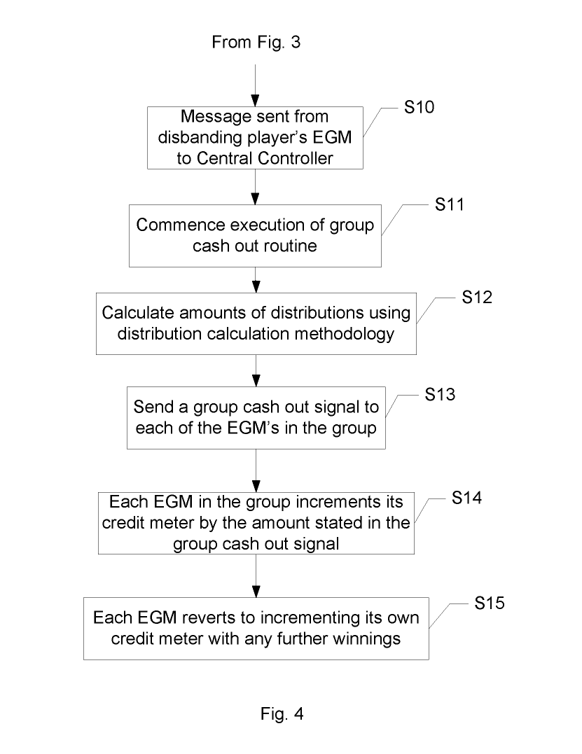

Referring to the embodiment of the method shown in FIGS. 3 and 4, a group is defined in response to player inputs that are provided at step S1 via input modules 7 and 8. For the sake of providing a running example, we shall assume that the player of EGM 3 wishes to establish a group and hence this player makes a suitable input via the input module on EGM 3, which puts EGM 3 into a group defining mode. In this mode, the player provides further inputs in response to queries from EGM 3, which define the parameters of the new group that the player wishes to establish. The first of these queries defines if the group is to be open or closed. An open group may be joined by any player wishing to do so. A closed group is only capable of being joined by a specific list of known players. For the sake of the running example, we shall assume that the player selects the closed option. In response to this selection, EGM 3 provides the player with an opportunity to input the player identification numbers (or other identifying data) associated with the specific players for whom the group is being established. For the sake of the running example, we shall assume that the player enters the player identification numbers of two other players who are friends of the player of EGM 3 and who are currently active on other EGM's 1 and 4. Hence, the maximum number of players that may participate in the proposed group is three (i.e. the player who is establishing the group and the two other identified players).

At step S2 EGM 3 communicates the two entered player identification numbers to the central controller 20. At step S3 the central controller ascertains the EGM's at which the two other identified players are currently playing. For the sake of the running example, we shall assume that they are currently playing on EGM 1 and EGM 4. The central controller then communicates with EGM 1 and EGM 4, in response to which those EGM's, at step S4, query their players to check if they wish to join the proposed group. These two players then provide an input via their respective player operable input modules to indicate whether they opt to join their EGM's into the group. For the sake of the running example, we shall assume that both of the players of EGM 1 and EGM 4 opt to join the group and hence the EGM's of all three of the players are now in the group.

At the point of formation of the group, if any of the joining players already have credits on the credit meter of their EGM, for example due to winnings from play prior to joining the group, the pre-existing winnings are not transferred to the group pool. Rather, they are retained separately on each EGM as credit. It is only winnings that occur whilst their EGM is in the group that will be transferred to the group pool in the manner described in more detail below.

An alternative way in which a group may be established is for the individuals involved to request the assistance of an employee of the gaming establishment who is authorized to set up such groups. In this scenario, the authorized employee ascertains the identification numbers of each of the players and the EGM's on which they are playing and makes a suitable input into the central controller 20 so as to define the group.

Upon the formation of the group, at step S5, the central controller 20 initialises variables to allow for the tracking of the amount of funds in the group pool and the total amounts staked on each game played whilst in the group by each of the players in the group.

These variables are all initialised to zero values. A shown at step S6, group gaming may now commence.

Whilst joined in the group, at step S7, each of the EGM's 1, 3 and 4 communicate the amount staked on each game to the central controller 20. For example, if the player of EGM 4 commences a game upon which that player has staked $2, EGM 4 communicates this to the central controller, which is configured to increment the variable representing the amount staked on EGM 4 whilst EGM 4 is in the group by $2.

Also whilst joined in the group, at step S8 each of the EGM's 1, 3 and 4 are configured to contribute the winnings they generate into a group pool. More specifically, each time one of the EGM's 1, 3 or 4 in the group generates winnings, it does not increment its own credit meter by the amount of the winnings in the conventional manner. Rather, it sends a message to the central controller 20 stating the amount of the winnings. In response to this message, the central controller 20 increments the variable representing the group pool by the amount of the winnings as stated in the message.

Also in response to the message received from the EGM that generated a win, the central controller 20 sends a message instructing the other EGM's to provide win notifications to the players of each of the other EGM's in the group. For example, assume that Joe, who is playing EGM 3, has previously entered his player identification number via his EGM 3, which is stored in the player tracking system. When Joe's EGM 3 subsequently generates a $25 win, EGM 3 will perform the usual win routine to notify Joe of his win. However, EGM 3 also communicates this to the central controller 20, which increments the group pool by $25 and looks up the first name of the player of EGM 3 from the player tracking system database based on the identification number of the player of EGM 3. This allows the central controller 20 to send a message to EGM 1 and EGM 4 that includes the amount of the win along with the first name of the player of the EGM that generated the win. Upon receipt of this message, both EGM 1 and EGM 4 provide a small side message alerting their players that “Joe just won $25”. This promotes excitement for all members of the group when any of them wins, which is appropriate given that the pooled winnings will eventually be distributed across the group. As shown in the embodiment illustrated in FIG. 1, this small side message 18 is displayed on the main display screen 5. However, in other embodiments, it is displayed using other hardware, such as on the display of a top box that in some embodiments is retrofitted to each of the EGM's or on an overhead display that is viewable by many or all of the players at the gaming establishment. Yet further embodiments make use of other types of notification, such as with the use of flashing lights or audible alerts such as bells and the like.

In the running example, all of the winnings from any of the EGM's in the group are contributed to the group pool. However, in other embodiments a proportion of the winnings is allocated to the credit meter of the EGM that generated the win and the remainder is allocated to the group pool. Another variation along these lines involves differentiating between winnings arising from primary games and winnings arising from secondary games. In such embodiments at least some of the EGM's are configured to execute both primary games (i.e. where the game result is substantially independent of gaming activity on the other EGM's) and secondary games (i.e. where the game result is substantially dependent not only on gaming activity at the EGM in question, but also upon gaming activity on the other EGM′, such as the well-known mystery value linked jackpot secondary games, for example). In some such embodiments, it is only the primary winnings that are transferred to the group pool and the secondary winnings are retained by the EGM that triggered the secondary win. In other such embodiments, it is only the secondary winnings that are transferred to the group pool and primary winnings are retained by the EGM that triggered the primary win. In yet other embodiments a proportion of both the primary winnings and the secondary winnings is retained by the EGM and the remainder is transferred to the group pool.

The group gaming continues until one of the players in the group decides at step S9 to disband the group. For the sake of the running example, we shall assume that the variables being tracked by the central controller 20 at the time of the disbanding of the group are as follows:
Amount of the group pool: $120
Amount staked by player of EGM 1 whilst in group: $50
Amount staked by player of EGM 3 whilst in group: $30
Amount staked by player of EGM 4 whilst in group: $20

The disbanding of the group occurs at step S9 when one of the players in the group makes a suitable input via the input module 7, 8 of their EGM 1, 3 or 4 requesting the disbandment. In response to this, at step S10 their EGM sends a message to the central controller 20 indicating that the group is to be disbanded. In response to this message, the central controller 20 at step S11 commences execution of a group cash out routine whereby funds from the group pool are distributed to players of the EGM's in the group in accordance with a distribution calculation methodology that is dependent upon the variables that have been tracked by the central controller 20. These calculations are performed at step S12. More particularly, the amount of the funds from the group pool to be distributed to a player as calculated by the distribution calculation methodology is proportional to the total amount staked by that player whist in the group relative to a total amount staked by all players whilst in the group. In the running example, the central controller 20 would perform the following calculations:
Total amount staked on the EGM's whilst in the group: $50+$30+$20=$100
Proportion of total staked by player of EGM 1: 50/100=0.5
Proportion of total staked by player of EGM 3: 30/100=0.3
Proportion of total staked by player of EGM 4: 20/100=0.2
Group pool funds to be distributed to EGM 1: 0.5*$120=$60
Group pool funds to be distributed to EGM 3: 0.3*$120=$36
Group pool funds to be distributed to EGM 4: 0.2*$120=$24

At step S13 the central controller 20 then sends a group cash out signal to each of the EGM's in the group. In the running example, this group cash out signal instructs EGM 1 to increment its credit meter by $60, EGM 3 to increment its credit meter by $36 and EGM 4 to increment its credit meter by $24. In response to receipt of these messages, at step S14, each of the EGM's executes a group cash out routine in which each EGM makes the required increments. At step S15 the group cash out routine also configures the EGM's in the group such that from this point onwards, each of those EGM's reverts to the conventional practice of incrementing its own credit meter with any further winnings.

Although other embodiments make use of alternative distribution calculation methodologies, an advantage associated with making a player's distribution amount proportional to the amount staked by that player whilst in the group, as shown in the running example above, is that this deals with a situation in which a player joins a group at the last minute prior to disbanding of that group. In this circumstance, if that player did not stake any bets whilst in the group, then that player would not receive any distribution from the group pool. Similarly, it deals with a situation in which a player joins a group, but only stakes a small amount whilst in that group.

As an alternative to disbanding the entire group, some embodiments provide an option for a player in a group to withdraw from the group whilst allowing the other players to remain in the group. Referring back to the running example prior to disbandment, we shall assume that the player of EGM 1 chooses to withdraw from the group. The player of EGM 1 makes a suitable input on the player operable input module 7, which causes EGM 1 to send a signal to the central controller 20 indicating that EGM 1 is withdrawing. In response to this, the central controller 20 calculates the distribution amount that the player of EGM 1 is entitled to at that point in time. In the running example, this amount is $60. This amount is subtracted from the group pool, leaving $60 remaining in the group pool. The central controller 20 then sends a message to EGM 1 instructing it to increment its meter by $60 and configuring EGM 1 such that any further winnings will be incremented to its own credit meter. However, EGM 3 and EGM 4 remain in the group and the further winnings generated by either of those EGM's will continue to be added to the $60 remaining in the group pool.

Another embodiment of the invention allows for the group to be maintained for a predefined length of time, for example a number of hours, days, weeks, months, etc. This length of time is defined when the group is initially established and the central controller 20 monitors the elapsing of this time. Once the predefined length of time has elapsed, the central controller 20 automatically disbands the group and initiates execution of the group cash out routine. At this point it is possible that some or all of the members of the group may no longer be physically present at the gaming establishment.

For this reason, in this embodiment the group cash out routine does not involve distribution of the funds from the group pool to the EGM's. Rather, in this embodiment the group cash out routine, as executed by the central controller 20, involves calculation of the distribution amounts for each player in the group and incrementing of the credits in their respective player tracking system accounts by those amounts. This allows the distributed winnings to be effectively received on the players' behalf, even if they are not physically present at the gaming establishment at the time when the group cash out routine is executed.

Another way in which the group can be disbanded is at the behest of an authorized operator, who is typically an employee of the gaming establishment. To do so, the authorized operator provides a suitable input to the central controller 20, in response to which group is disbanded and the group cash out routine is executed.

In another embodiment of the invention, the gaming apparatus is configured so as to allow a definition of at least two groups of EGM's from amongst the plurality of EGM's. In this embodiment the at least two groups can engage in group play simultaneously and the gaming apparatus is configured to allow the at least two groups to compete against each other. At the conclusion of the group play session, a bonus or jackpot prize is awarded to the players in the winning group.

A running example of such an embodiment is provided by a network of slot machine EGMs. In this embodiment the gaming apparatus defines two groups of EGMs, which we shall label Group 1 and Group 2. The two groups preferably have an equal number of EGM's to help promote fairness given that the two groups will be competing against each other. These groups are defined as outlined above by player inputs into the player input modules (although in an alternative embodiment, the two groups may be defined other means, such as by inputs made by an authorized operator directly onto the central controller 20). For the sake of the running example, we shall assume that Group 1 comprises EGM 1 and EGM 2 and Group 2 comprises EGM 4 and EGM 5. These two groupings continue for a pre-defined length of time, which is 1 hour in our running example.

Once the two groups have been defined, the central controller 20 initialises zero values for a Group 1 pool variable and a Group 2 pool variable. Additionally, the central controller initialises variables that will track the amounts staked by each of the players of the EGM's in Groups 1 and 2.

Group play commences at the same time for both Group 1 and Group 2. As described above, the a proportion, which in the preferred embodiment is 90%, of the winnings of Group 1 are incremented into a Group 1 pool and the same proportion of the winnings of Group 2 are incremented into a Group 2 pool. The remaining 10% of Group 1 winnings and the remaining 10% of Group 2 winnings are each incremented into a single jackpot. For the sake of the running example we shall assume that at the end of the group play, the variables being tracked by the central controller 20 are as follows:
Amount staked on EGM 1 whilst in Group 1: $120
Amount staked on EGM 2 whilst in Group 1: $150
Amount staked on EGM 4 whilst in Group 2: $100
Amount staked on EGM 5 whilst in Group 2: $130
Total amount staked whilst in Group 1: $120+$150=$270
Total amount staked whilst in Group 2: $100+$130=$230
Amount won on EGM 1 whilst in Group 1: $90
Amount won on EGM 2 whilst in Group 1: $170
Amount won on EGM 4 whilst in Group 2: $110
Amount won on EGM 5 whilst in Group 2: $160
Group 1 pool=0.9*($90+$170)=$234
Group 2 pool=0.9*($110+$160)=$243
Jackpot: $26+27=$53

At the conclusion of the group play session (i.e. once 1 hour has elapsed), the central controller 20 compares the amount of the Group 1 pool to the amount of the Group 2 pool. The group with the highest amount wins. In the running example, Group 2 is the winner (because $243 is higher than $234) and hence the $53 jackpot is added to the Group 2 group pool, giving a Group 2 pool of $243+$53=$296. A jackpot win notification message is sent from the central controller 20 to EGM 4 and EGM 5, in response to which, these EGM's notify their players of the jackpot win.

The central controller 20 then uses the distribution calculation methodology to calculate the amounts to be distributed to each of the players in Group 1 and Group 2. In the running example, these calculations are as follows:
Proportion of Group 1 stake staked by player of EGM 1: 120/270=0.4444
Proportion of Group 1 stake staked by player of EGM 2: 150/270=0.5555
Proportion of Group 2 stake staked by player of EGM 4: 100/230=0.4348
Proportion of Group 2 stake staked by player of EGM 5: 130/230=0.5652
Group 1 pool funds to be distributed to EGM 1: 0.4444*$234=$104
Group 1 pool funds to be distributed to EGM 2: 0.5555*$234=$130
Group 2 group pool funds to be distributed to EGM 4: 0.4348*$296=$128.70
Group 2 group pool funds to be distributed to EGM 5: 0.5652*$296=$167.30

The central controller 20 then sends a group cash out signal to each of the EGM's in Groups 1 and 2, which causes them to increment their credit meters by the applicable amounts as calculated above and disbands the groupings, which configures each EGM to revert to crediting its winnings to its own credit meter in the usual fashion.

In yet another embodiment, the gaming venue operator provides inputs to the central controller 20, which defines criteria for automatically providing players with the option to join one or more groups. In one such embodiment, the gaming venue operator may specify a time of day, for example 2:00 pm, at which all currently active EGM's are to provide their player with the option to join into a group. In one such example, groupings of EGM's are automatically proposed based on the physical clustering of the EGM's.

That is, a first proposed group may be based on the EGM's that are clustered about a first portion of the gaming establishment, a second proposed group may be based on the EGM's that are clustered about a physically separate portion of the gaming establishment, and so forth.

When the central controller's clock strikes 2:00 pm, it sends a message to the currently active EGM's in each proposed group. In response to this message, each EGM provides its player with an option to join the group defined by the EGM's physical proximity to other EGM's within the gaming establishment. The players make an input via the input modules 7, which either enters their EGM into the proposed group, or declines the offer in which case the EGM continues to increment its wins to its own credit meter.

While a number of preferred embodiments have been described, it will be appreciated by persons skilled in the art that numerous variations and/or modifications may be made to the invention without departing from the spirit or scope of the invention as broadly described. The present embodiments are, therefore, to be considered in all respects as illustrative and not restrictive.

What is claimed is:

1. A gaming apparatus comprising:
a plurality of communicatively interlinked electronic gaming machines (EGMs), each of the EGMs being configured to execute a game having a potential to generate winnings;
the gaming apparatus being configured so as to allow a definition of a group of EGM's from amongst the plurality of EGM's;
each of the EGM's being configured to contribute at least some of the winnings generated by the EGM whilst the EGM is in the group into a group pool;
the gaming apparatus being configured to execute a group cash out routine whereby funds from the group pool are distributed to players of the EGM's in the group in accordance with a distribution calculation methodology.

2. The gaming apparatus according to claim 1 wherein each of the EGMs is responsive to a player operable input module so as to allow a player of the EGM to define the group.

3. The gaming apparatus according to claim 1 wherein each of the EGMs is responsive to a player operable input module so as to allow a player of the EGM to opt to join the EGM into the group.

4. The gaming apparatus according to claim 1 wherein the gaming apparatus is configurable by an authorized operator so as to define a group.

5. The gaming apparatus according to claim 1 wherein the gaming apparatus is configured to maintain the group for a predefined length of time, after which the group is automatically disbanded and the group cash out routine is executed.

6. The gaming apparatus according to claim 1 wherein each of the EGMs in the group is responsive to a player operable input module so as to allow a player of the EGM to opt to disband the group, in response to which the gaming apparatus is configured to execute the group cash out routine.

7. The gaming apparatus according to claim 1 wherein the gaming apparatus is operable by an authorized operator so as to disband the group and execute the group cash out routine.

8. The gaming apparatus according to claim 1 wherein at least some of the EGM's are configured to execute a primary game having a potential to generate primary winnings wherein a primary game result is substantially independent of gaming activity on the other EGM's and a secondary game having a potential to generate secondary winnings wherein a secondary game result is substantially dependent upon gaming activity on the other EGM's.

9. The gaming apparatus according to claim 8 wherein an EGM generating primary winnings whilst that EGM is in the group is configured to contribute at least some of the primary winnings generated by the EGM into the group pool.

10. The gaming apparatus according to claim 8 wherein an EGM generating secondary winnings whilst that EGM is in the group is configured to contribute at least some of the secondary winnings generated by the EGM into the group pool.

11. The gaming apparatus according to claim 1 wherein the gaming apparatus is responsive to a win generated by one of the EGM's in the group so as to provide a win notification to the players of each of the other EGM's in the group.

12. The gaming apparatus according to claim 1 wherein each of the EGM's in the group is responsive to a group cash out signal so as to execute the group cash out routine in which a credit meter of each EGM is incremented by funds from the group pool in accordance with the distribution calculation methodology.

13. The gaming apparatus according to claim 1 wherein each of the EGM's is configured to receive an identifier of a player of that EGM and to access information stored within an account associated with the player.

14. The gaming apparatus according to claim 13 wherein each of the EGM's in the group is responsive to a group cash out signal so as to execute the group cash out routine in which the account associated with each player of each EGM in the group is incremented by funds from the group pool in accordance with the distribution calculation methodology.

15. The gaming apparatus according to claim 1 wherein the distribution calculation methodology is dependent upon a total amount staked by each player whist in the group.

16. The gaming apparatus according to claim 15 wherein an amount of the funds from the group pool distributed to a player as calculated by the distribution calculation methodology is proportional to the total amount staked by that player whist in the group relative to a total amount staked by all players whilst in the group.

17. The gaming apparatus according to claim 1 wherein the gaming apparatus is configured so as to allow a definition of at least two groups of EGM's from amongst the plurality of EGM's.

18. The gaming apparatus according to claim 17 wherein the gaming apparatus is configured to allow the at least two groups to compete against each other.

19. The gaming apparatus according to claim 18 wherein a winning group is determined and a bonus or jackpot prize is awarded to the players in the winning group.

20. A gaming method comprising the steps of:
providing a plurality of communicatively interlinked electronic gaming machines (EGMs), each of the EGMs being configured to execute a game having a potential to generate winnings;
defining a group of EGM's from amongst the plurality of EGM's;
contributing at least some of the winnings generated by the EGM whilst the EGM is in the group into a group pool; and
executing a group cash out routine whereby funds from the group pool are distributed to players of the EGM's in the group in accordance with a distribution calculation methodology.
